(19) United States
(12) Patent Application Publication
(10) Pub. No.: US 2020/0240530 A1
(43) Pub. Date: Jul. 30, 2020

(54) INTEGRATED COPPER PRESS-FIT CONNECTION BALL VALVE

(71) Applicant: Conbraco Industries, Inc., Matthews, NC (US)

(72) Inventors: Brian Gantz, Matthews, NC (US); Greg Goodson, Matthews, NC (US)

(21) Appl. No.: 16/434,612

(22) Filed: Jun. 7, 2019

Related U.S. Application Data
(60) Provisional application No. 62/798,155, filed on Jan. 29, 2019.

(51) Int. Cl. F16K 5/06

(52) U.S. Cl. CPC F16K 5/0657

(57) ABSTRACT

An integral copper press-fit connection ball valve is provided which includes a bronze central body defining a chamber and a flow path between an upstream inlet and a downstream outlet. A ball having a through passageway is positioned in the chamber and adapted to rotate between an open flow position and a closed flow position. A copper inlet press-fit retainer is connected to the inlet, and a copper outlet press-fit retainer is connected to the outlet. A ball valve seat is positioned within an inner diameter of each retainer and adapted to be compressed between the ball and the retainers on respective upstream and downstream sides of the ball for retaining the ball in a correct and functional position.

### CROSS REFERENCE TO RELATED PATENT APPLICATIONS

This application claims the benefit of and priority to U.S. Provisional Patent Application No. 62/798,155 filed Jan. 29, 2019, herein expressly incorporated by reference in its entirety.

### TECHNICAL FIELD AND BACKGROUND OF THE INVENTION

This invention relates to a ball valve with press-fit connections. Specifically, this invention relates to copper press-fit connections integrated with a bronze body ball valve.

Stress corrosion cracking (SCC) has become an increasingly prevalent issue with brass press-fit connection valves and fittings. This is particularly the case in certain regions of the United States such as in New England, the Mid-West, and the North-West due to cold seasonal temperatures. While brass is a low cost and versatile material for valves and fittings, stress corrosive cracking failures create a need for an alternative solution.

In one attempt to resolve stress corrosive cracking failures, copper press adapters are threaded onto the end of a more traditional NPT (national pipe thread) end connection valve. This solution creates separate parts which can increase other types of failures and create more cost and effort to install, repair, and maintain. Other ball valves are manufactured with integrated press-fit connections; however these ball valves are not made of materials that prevent stress corrosion cracking.

There is a need for an integrated press-fit connection ball valve that eliminates and/or reduces stress corrosion potential at reasonable cost.

### SUMMARY OF THE INVENTION

It is therefore an object of the present invention to provide a ball valve with integrated copper press-fit connections.

These and other objects and advantages of the present invention are achieved in the preferred embodiments set forth below by providing an integral copper press-fit connection ball valve which includes a bronze central body defining a chamber and a flow path between an upstream inlet and a downstream outlet. A ball having a through passageway is positioned in the chamber and adapted to rotate between an open flow position and a closed flow position. A copper inlet press-fit retainer is connected to the inlet, and a copper outlet press-fit retainer is connected to the outlet. A ball valve seat is positioned within an inner diameter of each retainer and adapted to be compressed between the ball and the retainers on respective upstream and downstream sides of the ball for retaining the ball in a correct and functional position.

According to another embodiment of the invention, the retainers each have a press-fit end for connecting to press-fit compatible devices and a central body connection end for connecting to the central body.

According to another embodiment of the invention, the retainers are connected to the central body by threads formed on an outer diameter of the retainers positioned proximate to the central body connection end of the retainers which cooperate with threads formed on an inner diameter of the central body positioned proximate to the inlet and outlet.

According to another embodiment of the invention, a supplemental locking material is applied to the threads.

According to another embodiment of the invention, an enlarged radius shoulder is formed on the outer diameter of the retainers at a position proximate to and laterally inward from the threads on the retainers, and is adapted engage outlet and inlet end surfaces of the central body.

According to another embodiment of the invention, the ball valve seats are positioned within a notch on an inner diameter of each retainer and adapted to be compressed between the ball and the retainers on the upstream and downstream sides of the ball.

According to another embodiment of the invention, the retainers are made from a copper alloy.

According to another embodiment of the invention, the retainers are made from wrot copper.

According to another embodiment of the invention, the central body is made from a copper alloy which includes zinc.

According to another embodiment of the invention, the retainers are made from copper alloy UNS C12200.

According to another embodiment of the invention, the central body is made from Bronze UNS C89836.

According to another embodiment of the invention, the retainers have a channel running along at least a portion of the lengthwise distance from inlet to outlet of the retainers. According to another embodiment of the invention, the channel has a square cross section. According to another embodiment of the invention, a copper press-fit connection ball valve is provided which includes a bronze central body defining a chamber and a flow path between an upstream inlet and a downstream outlet. A ball having a through passageway is positioned in the chamber and adapted to rotate between an open flow position and a closed flow position. A copper inlet press-fit retainer is connected to the inlet and a copper outlet press-fit retainer connected to the outlet. A seat is positioned within a notch in an inner diameter of each retainers and each seat adapted to compress between the ball and the respective retainer on both sides of the ball for retaining the ball in a correct and functional position.

### BRIEF DESCRIPTION OF THE DRAWING FIGURES

The present invention is best understood when the following detailed description of the invention is read with reference to the accompanying drawings, in which:

FIG. 1 is a prior art ball valve with copper press adapters on each end of the valve;

FIG. 2 is a prior art ball valve with integrated brass press-fit connection fittings;

FIG. 3 is an exploded vertical cross-sectional view of a ball valve according to the present invention in an open flow position;

FIG. 4 is an exploded side view of the ball valve in FIG. 3;

FIG. 5 is a vertical cross-sectional view of the assembled ball valve according to the present invention in an open flow position; and

FIG. 6 is a side view of the ball valve in FIG. 5.

### DETAILED DESCRIPTION OF THE PREFERRED EMBODIMENT

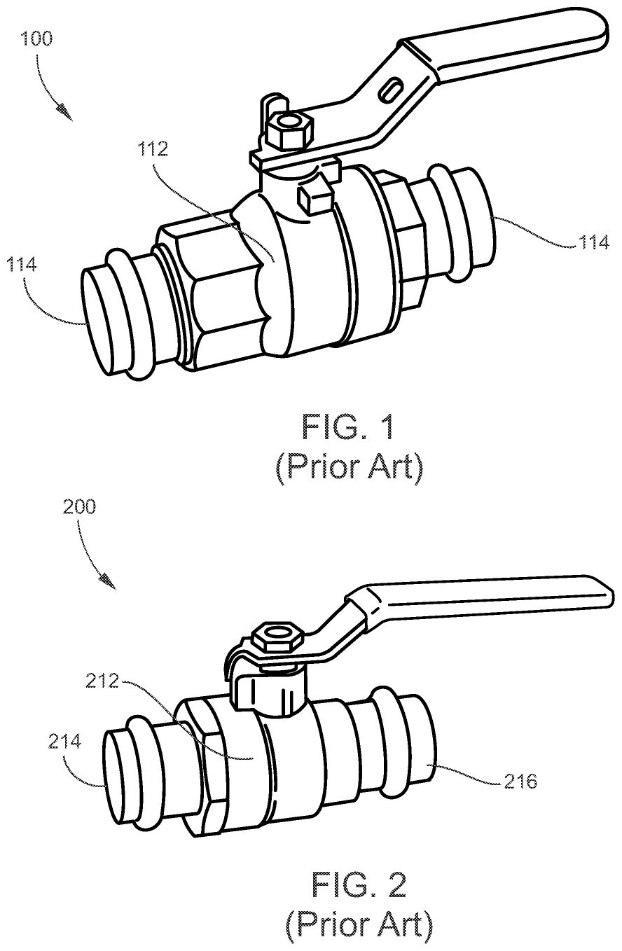

Prior art attempts to resolve stress corrosion (SCC) cracking have not yielded as successful results as needed. In one prior art valve 100, shown in FIG. 1, a conventional ball housing 112 having NPT ends are fitted with off-the-shelf copper press adapters 114, 116. These copper press adapters 114, 116 do not seamlessly integrate with the ball housing 112 as they are merely screwed into the already existing ball housing 112 NPT threads and are not integral with the formation of the ball valve 100 and are thus less than ideal to mitigate SCC. While adapters are often a quick solution, they are not always ideal as the component being fitted with an adapter is not designed to be integral.

Another prior art valve 200, shown in FIG. 2, is an brass body housing 212 with brass press-fit ends 214, 216 instead of NPT ends. This prior art valve 200 is integrated and fully made of brass. These are often one machined piece of brass to fit the desired specifications and maintain brass press-fit ends 214, 216 which are prone to SCC problems, particularly in colder climates.

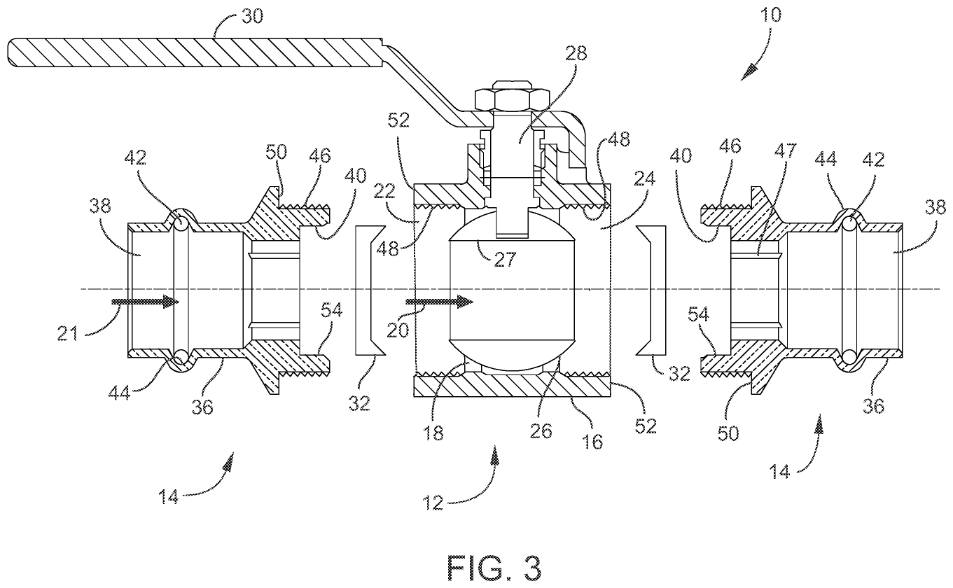

Referring now to FIGS. 3-6, a copper press-fit connection ball valve 10 is shown having a central ball valve section 12 positioned between two identical press-fit connection retainer sections 14 (“retainers”). The central section 12 has a central valve body 16 defining an internal valve chamber 18 and a flow path 20 through and along a longitudinal axis of the valve body 16. The flow path 20 has a circular cross-section in a plane perpendicular to the longitudinal axis of the valve body 16 proximate to a fluid inlet 22 and a fluid outlet 24 of the valve body 16. A valve ball 26 is positioned inside the valve chamber 18 and is rotated by a stem 28 connected to a quarter-turn handle 30 to achieve rotation between different operating positions in order to control the flow of fluid through the valve 10.

The ball 26 has a substantially spherical sealing surface having a fluid flow passage 27 which extends linearly through the entire thickness of the ball 26 and has an outer diameter substantially equal to that of the flow path of the valve body 16, commonly called a full-port ball valve. In another embodiment, a fluid flow passage has a diameter less than that of the flow path of a valve body, commonly called a reduced, or standard, port ball valve. The handle 30 rotates the ball 26 between an open flow position where the fluid flow passage 27 of the ball 26 is aligned with the flow path 20 and fluid is able to flow from inlet 22 to outlet 24, and a closed flow position where the fluid flow passage 27 of the ball 26 is not aligned with the flow path 20 and fluid is unable to flow from inlet 22 to outlet 24.

The retainers 14 have a retainer body 36 defining a press-fit connection end 38, a central section connection end 40 and a retainer flow path 21 along a longitudinal axis of the retainer body 36. The retainer flow path 21 has a circular cross-section in a plane perpendicular to the longitudinal axis of the retainer body 36 proximate to the press-fit connection end 38. The central section connection end 40 of the retainer body 36 has a square or hex cross-section. The inner diameter, or “ID”, of the retainer 14 at the press-fit connection end 38, is typically sized to accommodate various hoses, pipes, and the like. The ID typically ranges from ½ inch to 2 inches for most applications but other applications may require different dimensions.

The press-fit connection end 38 is adapted to receive a pipe or other tubing which forms a connection commonly known as a “press-fit”, a “push-to-connect”, a “push-fit”, or a “press-end” connection. Press-fit connections work by pressing a male end into a female end of a press-fit type connection. The press-fit connection is made using a specialized tool which crimps an O-ring 42 tighter to the female end of a tubing. The O-ring 42 is partially housed within a groove 44 of the retainer body 36 and partially extends into the flow path 21 to create the sealed connection. The groove 44 is extends radially outward from a longitudinal axis of the retainer body 36. The groove 44 and O-ring 42 are longitudinally offset from the press-fit connection end 38 by a predetermined distance. While this offset distance is typically based on industry standards, other distances which meet the requirements of other various hoses, pipes and the like are also envisioned. The dimensions of the O-ring 42 are also based upon the requirements for coupling the valve 10 to the desired hose or pipe. The O-ring 42 can be made of, but is not limited to, rubber, synthetic rubber, or other materials with suitable sealing properties. Examples of specific materials include silicone, ethylene propylene (EPDM), and nitrile.

In order to overcome deficiencies in prior art valves, the valve 10 is integrally formed from copper retainers 14 connected on both the inlet 22 and outlet 24 ends of the bronze central section 12. The copper material of the retainers 14 will typically be a copper alloy, such as UNS C12200, which has the desired properties.

In the preferred embodiment the copper is wrot copper, however this invention is not limited to only wrot copper. The retainer 14 will ideally be forged and machined and/or machined from forged copper bars. Other formations are also envisioned such as 3d printing techniques, joining of sections through welding and/or chemical joining. The bronze material for the central body 12 will typically be a bronze, such as but not limited to UNS C89836, which has the desired properties. The bronze will be a copper alloy which contains zinc in a quantity below that of brass in the preferred embodiment. Formation of the central body 12 can be done by techniques described above. The retainers 14 and the central body 12 can be formed using the same technique, or using different techniques.

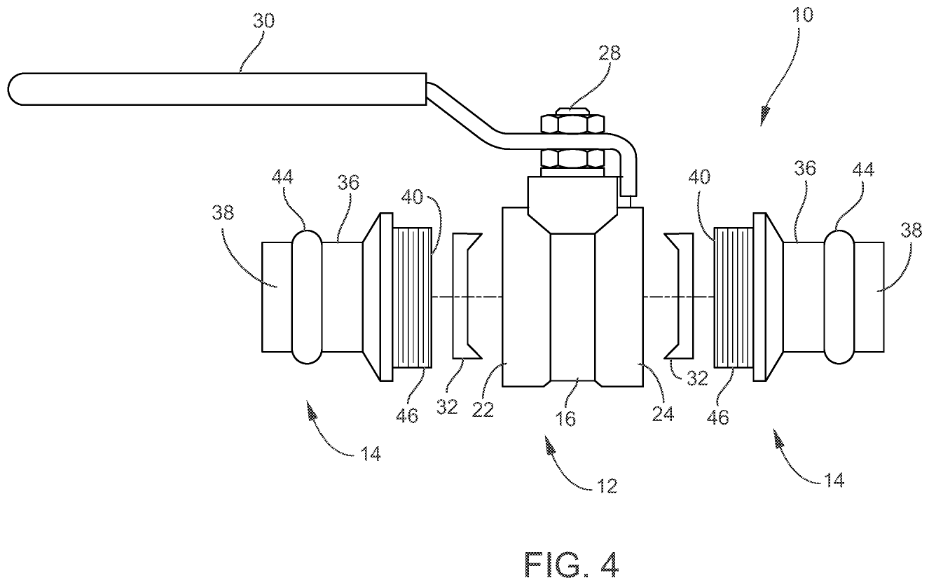

As best shown in the exploded views of FIGS. 3 and 4, an annular seat ring 32 is positioned axially between the retainer 14 and the central section 12 on each side of the ball 26. This results in an integral valve 10 as the retainer 14 is necessary for the functionality of the valve 10. The seat rings 32 are generally housed within a notched portion 54 of the retainer body 36 at the central section connection end 40 of the retainer 14. This results in an integral valve 10 as the retainer 14 is necessary for the functionality of the valve 10 as the seat rings 32 form a seal between the ball 26 and the retainer 14. The seat rings 32 are compressed between the ball 26 and the notch 54 such that fluid can only pass through the fluid passage 27 of the ball 26 when the valve 10 is in an open flow position. The seat rings 32 can be formed, in whole or in part, from various materials including, but not limited to, elastomeric materials, flexible materials, soft metals, and/or coated metals.

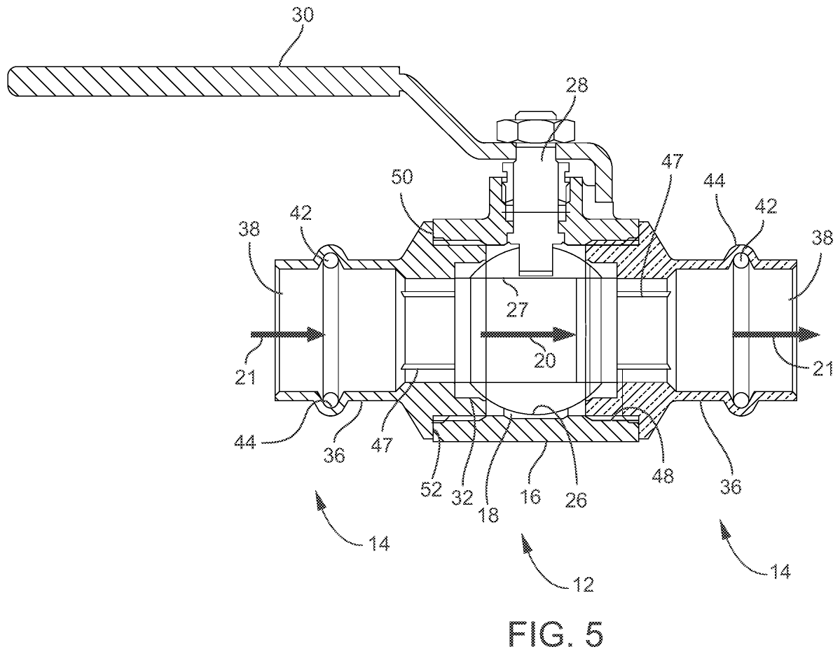

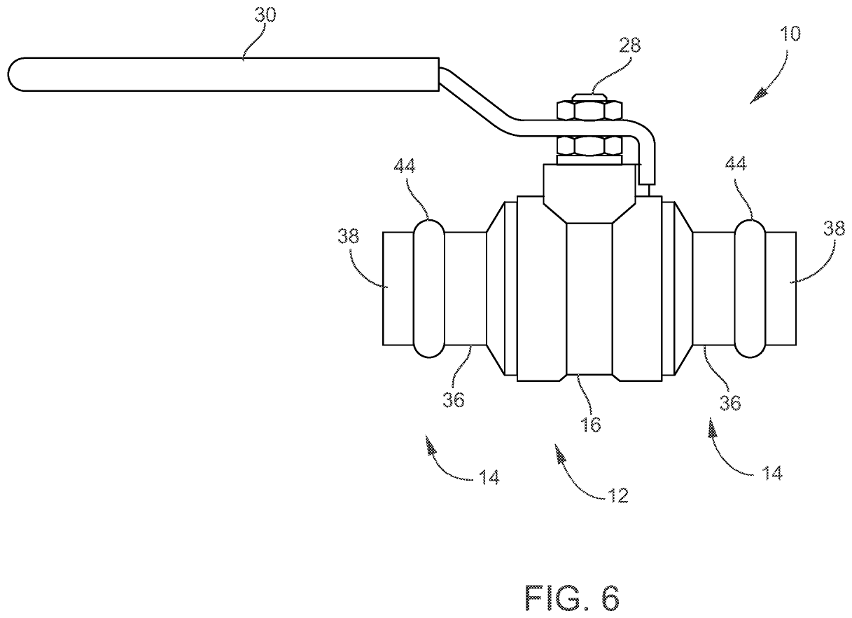

FIGS. 5 and 6 show the assembled valve 10 where the connection between the retainers 14 and the central section 12 are connected by cooperating threads 46, 48. Note that these threads 46, 48 are distinguished from prior art valves in that the valve 10 would not function without the specific retainers 14 which connect to the central section 12 in order to form the integral valve 10. Retainer threads 46 are positioned on an outer diameter of the retainer body 36 proximate to the central section connection end 40. Valve body threads 48 are positioned on an inner diameter of the valve body 16 proximate to both the inlet 22 and the outlet 24. The retainer threads 46 cooperate with the valve body threads 48 resulting in an overlap between the valve body 16 and the retainer body 36. Tightening the retainer body 36 to the valve body 16 to a specific torque is done by a broach 47, or channel, which runs along at least a portion of the retainer body's inner diameter. The broach 47 extends in a radial outward direction into the retainer body 36, but does not pass all the way through the retainer body 36. A cross-section is formed by the broach 47 within the retainer body 36 on its inner diameter. That cross-section can be square, round, rectangular, or any other shape that enables the retainer body 36 to be tightened onto the valve body 16. The inner diameter of the retainer body 36 can have more than one broach 47 of the same cross-section, or of different cross-sections. This tightening can be achieved by flat slots positioned on the retainer body's outer diameter as well. To prevent loosening, leakage, and/or corrosion an adhesive or thread locker, such as a product sold under the trademark Loctite, can be used in conjunction with the threads. Other joining methods include chemical joining, welding, adhesives, clamps, and/or other suitable fasteners.

To further achieve the integral valve 10, an enlarged radius shoulder 50 is provided on the retainer body 36 outer diameter and inner diameter respectively. The shoulder 50 protrudes radially outward and has a generally flat surface perpendicular to the flow path 21. Positioning of the shoulder 50 is such that when the threads 46, 48 are connected for valve 10 assembly, the shoulder 50 engages a flat end surface 52 of the central valve body 16. The shoulder 50 and the end surface 52 mutually align along the outer diameter of the retainer body 36 and the valve body 16 resulting in a relatively even transition and an integral valve 10.

A ball valve according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

We claim:

1. An integral copper press-fit connection ball valve, comprising:
(a) a bronze central body defining a chamber and a flow path between an upstream inlet and a downstream outlet;
(b) a ball having a through passageway positioned in the chamber and adapted to rotate between an open flow position and a closed flow position;
(c) a copper inlet press-fit retainer connected to the inlet;
(d) a copper outlet press-fit retainer connected to the outlet; and
(e) a ball valve seat positioned within an inner diameter of each retainer and adapted to be compressed between the ball and the retainers on respective upstream and downstream sides of the ball for retaining the ball in a correct and functional position.

2. A ball valve according to claim 1, wherein the retainers each have a press-fit end for connecting to press-fit compatible devices and a central body connection end for connecting to the central body.

3. A ball valve according to claim 2, wherein the retainers are connected to the central body by threads formed on an outer diameter of the retainers positioned proximate to the central body connection end of the retainers which cooperate with threads formed on an inner diameter of the central body positioned proximate to the inlet and outlet.

4. A ball valve according to claim 3, wherein a supplemental locking material is applied to the threads.

5. A ball valve according to claim 3, wherein an enlarged radius shoulder is formed on the outer diameter of the retainers at a position proximate to and laterally inward from the threads on the retainers, and is adapted engage outlet and inlet end surfaces of the central body.

6. A ball valve according to claim 1, wherein the ball valve seats are positioned within a notch on an inner diameter of each retainer and adapted to be compressed between the ball and the retainers on the upstream and downstream sides of the ball.

7. A ball valve according to claim 1, wherein the retainers are made from a copper alloy.

8. A ball valve according to claim 1, wherein the retainers are made from wrot copper.

9. A ball valve according to claim 1, wherein the central body is made from a copper alloy which includes zinc.

10. A ball valve according to claim 1, wherein the retainers are made from copper alloy UNS C12200.

11. A ball valve according to claim 1, wherein the central body is made from Bronze UNS C89836.

12. A ball valve according to claim 1, wherein the retainers have a channel running along at least a portion of the lengthwise distance from inlet to outlet of the retainers.

13. A ball valve according to claim 12 wherein the channel has a square cross section.

14. A copper press-fit connection ball valve, comprising:
(a) a bronze central body defining a chamber and a flow path between an upstream inlet and a downstream outlet;
(b) a ball having a through passageway positioned in the chamber and adapted to rotate between an open flow position and a closed flow position;
(c) a copper inlet press-fit retainer connected to the inlet;
(d) a copper outlet press-fit retainer connected to the outlet; and
(e) a seat positioned within a notch in an inner diameter of each retainers and each seat adapted to compress between the ball and the respective retainer on both sides of the ball for retaining the ball in a correct and functional position.
